(19) United States
(12) Patent Application Publication
(10) Pub. No.: US 2018/0301675 A1
(43) Pub. Date: Oct. 18, 2018

(54) BATTERY WIRING MODULE

(71) Applicant: Sumitomo Wiring Systems, Ltd., Yokkaichi (JP)

(72) Inventors: Hiroshi SATO, Yokkaichi (JP); Ryota MORI, Yokkaichi (JP)

(21) Appl. No.: 15/935,351

(22) Filed: Mar. 26, 2018

(30) Foreign Application Priority Data
Apr. 14, 2017 (JP) 2017-080873

(51) Int. Cl. H01M 2/10; H01M 2/20

(52) U.S. Cl. CPC H01M 2/1077; H01M 2220/20; H01M 2/206

(57) ABSTRACT

When a cover of a battery module is to be closed, a wire may get caught between a wall of a housing and the cover. Large covers that have a rectangular plate shape are coupled to the upper end of an outer peripheral wall portion, using hinges. Lock pieces that are substantially U-shaped protrude from leading edges of the large covers. Each lock piece is formed such that both ends of the U shape are coupled to the leading edge of a large cover. The large covers are provided with guide portions that protrude downward when the large covers are in a closed state. The guide portions are coupled to central portions, in the depth direction, of the surfaces of the lock pieces on the hinges side. Each guide portion has a flat surface that is flush with a leading end surface of a lock piece, and an inclined surface that is inclined such that the protrusion length of the guide portion decreases in a direction from a hinge side end of the flat surface toward the hinge.

### CROSS REFERENCE TO RELATED APPLICATIONS

This application claims the priority of Japanese patent application JP2017-080873 filed on Apr. 14, 2017, the entire contents of which are incorporated herein.

### TECHNICAL FIELD

The present invention relates to a battery wiring module that is to be attached to an on-board secondary battery.

### BACKGROUND ART

JP 2011-65863A discloses a battery wiring module that is to be attached to an on-board secondary battery. The battery wiring module disclosed in JP 2011-65863A is provided with a box-shaped housing that is attached to the upper side of the secondary battery. A partition wall is provided on the bottom surface of the housing so as to stand upright. This partition wall defines, in the housing, wiring housing chambers for housing wiring that is electrically connected to the secondary battery. Also, an outer peripheral wall portion is provided on the outer periphery of the bottom surface of the housing so as to stand upright. Covers are coupled to the upper end of the outer peripheral wall portion so as to be pivotable relative to the upper end of the outer peripheral wall portion. With the battery wiring module according to JP 2011-65863A, it is possible to cover the wiring housing chambers with the covers from above by pivoting and closing the covers.

JP 2011-65863A is an example of related art.

### SUMMARY

In the battery wiring module according to JP 2011-65863A, a plurality of wires are housed in the wiring housing chambers of the housing. Therefore, some of the plurality of wires may protrude to the outside of a wiring housing chamber during the process of placing the wires in the wiring housing chambers. Also, if the wires, which are to be housed in the wiring housing chambers, have a crease or the like, the wires may protrude to the outside of a wiring housing chamber during the process of placing the wires in the wiring housing chambers. If a cover is pivoted to cover a wiring housing chamber from above in a state where the wires protrude from the wiring housing chamber, some of the wires may get caught between the cover and a wall of the housing (e.g. the partition wall) when the cover is closed. If a wire gets caught between a cover and a wall of the housing, there is the risk of the wire breaking or the like.

To solve the above-described problem, the present design provides a battery wiring module that is provided with a housing that is to be attached to an on-board secondary battery, and in which a wiring housing chamber for housing wires that are electrically connected to the secondary battery is defined by a partition wall that stands upright on a bottom surface of the housing. A cover is coupled to an upper end of a wall portion that stands upright on the bottom surface of the housing, so as to be pivotable relative to the upper end of the wall portion, the cover is provided with a first lock portion that protrudes downward when the cover is closed so as to cover the wiring housing chamber from above, the partition wall is provided with a second lock portion that engages with the first lock portion to hold the cover in a closed state, the cover is provided with a guide portion that protrudes downward when the cover is in a closed state, and the guide portion is coupled to a side of the first lock portion, the side being closer to a pivot axis of the cover than the other side is, and the guide portion has an inclined surface that is inclined such that a protrusion length of the guide portion decreases in a direction toward the pivot axis.

With the above-described configuration, even if a wire protrudes above a wiring housing chamber when the cover is pivoted and closed, the protruding wire can abut against the inclined surface of the guide portion while the cover is closed. Then, the wire is pressed toward and housed in the wiring housing chamber that is located closer to the pivot axis than the restriction wall is, by the inclined surface of the guide portion. Therefore, it is possible to prevent the wire from getting caught between the cover and a wall of the housing when the cover is closed.

In the above-described design, the first lock portion may protrude from an edge of the cover, the edge being located farther from the pivot axis than the other edge is, the second lock portion may be provided so as to protrude from the partition wall toward the pivot axis of the cover, and the first lock portion may be located closer to the pivot axis than the partition wall is when the cover is in a closed state.

With the above described configuration, it is possible to release the cover from a closed and held state by inserting a finger or a tool from above the battery wiring module and causing a portion of the partition wall where the second lock portion is provided to warp away from the pivot axis of the cover. Therefore, when releasing the cover from a closed and held state, it is easier to perform an operation compared to inserting a finger or a tool from a lower side on which the secondary battery is located.

In the above-described design, a restriction wall that stands upright on the bottom surface of the housing may be provided at a position that is closer to the pivot axis than the partition wall is, so as to face the partition wall, the restriction wall may be provided with a slit that extends downward from an upper end of the restriction wall, and when the cover is in a closed state, the first lock portion may be located between the partition wall and the restriction wall, and the guide portion may be inserted into the slit.

With the above-described configuration, even if the first lock portion is displaced toward the pivot axis due to the cover warping, for example, the first lock portion abuts against the restriction wall and the first lock portion is restricted from moving further toward the pivot axis of the cover. Therefore, it is possible to prevent the cover from excessively warping so that the first lock portion separates from the second lock portion and the cover is unintentionally released from a closed and held state. Note that since a slit is provided in the restriction wall and the guide portion is inserted into the slit, the guide portion and the restriction wall do not interfere with each other when the cover is pivoted and closed.

In the above-described design, when the cover is pivoted about the pivot axis, a side surface of the restriction wall, the side surface being located farther from the pivot axis than the other side surface is, may be located farther from the pivot axis than a trajectory of a vertex of the inclined surface at a protruding leading end of the inclined surface is.

With the above-described configuration, it is possible to prevent a wire that protrudes above the wiring housing chamber from getting caught between the restriction wall of the housing and the guide portion, and from being pressed by the guide portion into a space between the restriction wall and the partition wall. Therefore, it is possible to more reliably guide the wire that protrudes above from the wiring housing chamber to the wiring housing chamber that is located closer to the pivot axis of the cover than the restriction wall is.

In the above-described design, the cover, the first lock portion, and the guide portion may be integrally molded as one object that is made of resin, and the guide portion may have a flat surface that is flush with a protruding leading end surface of the first lock portion.

With the above-described configuration, a portion at which the guide portion and the first lock portion are coupled to each other is prevented from having an excessively small thickness. Therefore, when integrally molding the cover, the first lock portion, and the guide portion as one object by pouring resin into a cavity of a mold, it is possible to reliably distribute resin to a portion of the cavity that corresponds to a portion where the guide portion and the first lock portion are coupled to each other. Thus, it is possible to increase the yield of the battery wiring module.

With the present design, when the cover of the battery module is to be closed, it is possible to prevent a wire from getting caught between a wall of the housing and the cover.

### BRIEF DESCRIPTION OF THE DRAWINGS

FIG. 1 is a perspective view of a secondary battery and a battery wiring module.

FIG. 2 is a top view of the battery wiring module.

FIG. 3 is a cross-sectional view of the battery wiring module.

FIG. 4 illustrates how a cover is closed.

FIG. 5 illustrates how the cover is closed.

FIG. 6 is a partial perspective view of a cover according to a modification.

FIG. 7 is a cross-sectional view of a battery wiring module according to a modification.

### EMBODIMENTS

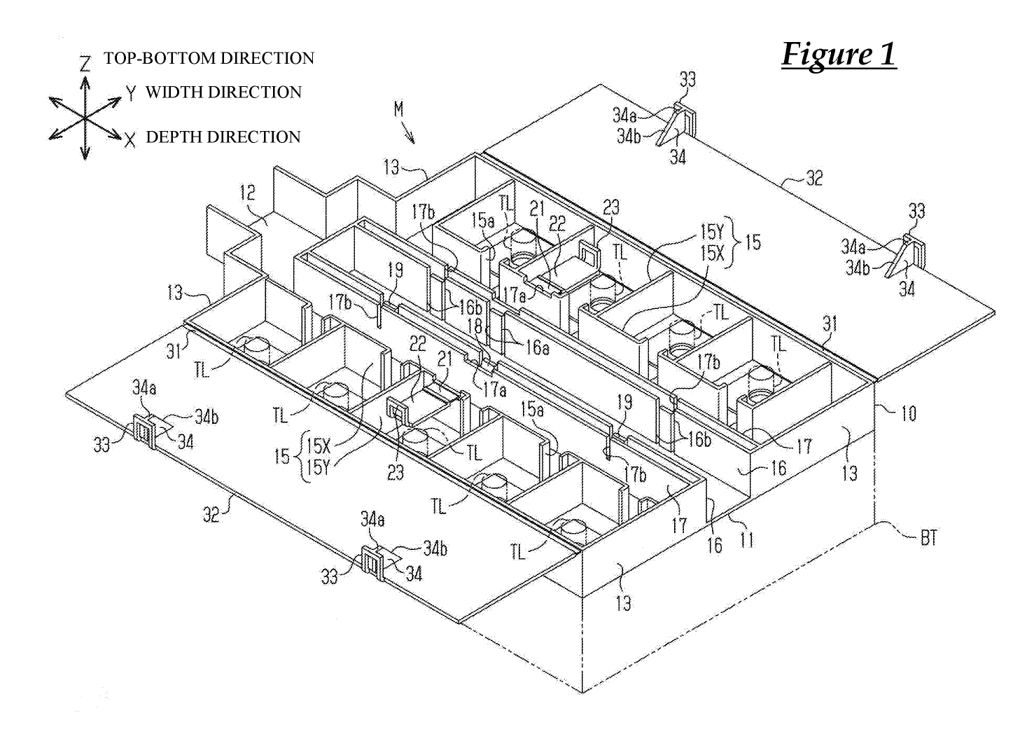

The following describes an embodiment of a battery wiring module with reference to FIGS. 1 to 5.

In the following description, out of three directions X, Y, and Z in FIG. 1 that are orthogonal to each other, the direction X is described as a depth direction of the battery wiring module, the direction Y is described as a width direction of the battery wiring module, and the direction Z is described as a top-bottom direction.

As shown in FIG. 1, a battery wiring module M is attached to the upper surface of a secondary battery BT that has a substantially parallelepiped shape. Note that the secondary battery BT is to be mounted on an electric vehicle, a hybrid vehicle, or the like, and supplies electric power to a motor for a vehicle to travel. Also, the secondary battery BT is supplied with electric power from a motor for the vehicle to travel or a motor for power generation, according to the charge state or driving state of the vehicle. A plurality of unit cells (not shown) are housed in the secondary battery BT, and positive and negative electrode terminals TL of each unit cell protrude upward.

The battery wiring module M is provided with a housing 10 that has a substantially square box-like external shape. A bottom wall portion 11 of the housing 10 has a rectangular plate shape that is longer in the depth direction than in the width direction. An extension portion 12, which is plate shaped, extends to one side in the depth direction from the edge of one side of the bottom wall portion 11 in the depth direction (the upper left side in FIG. 1). The extension portion 12 extends so as to be flush with the bottom wall portion 11. Outer peripheral wall portions 13 stand upright on outer peripheral edges of the upper surfaces of the bottom wall portion 11 and the extension portion 12 (the bottom surface of the housing 10). In the present embodiment, the outer peripheral wall portions 13, which stand upright, are not provided at positions in a central portion of the outer peripheral edge of the bottom wall portion 11 in the width direction and the leading edge of the extension portion 12. Wires L can be led out from the inside of the housing 10 to the outside or led in from the outside of the housing 10 to the inside via the positions where the outer peripheral wall portions 13 are not provided. Note that the wires L are omitted from FIG. 1.

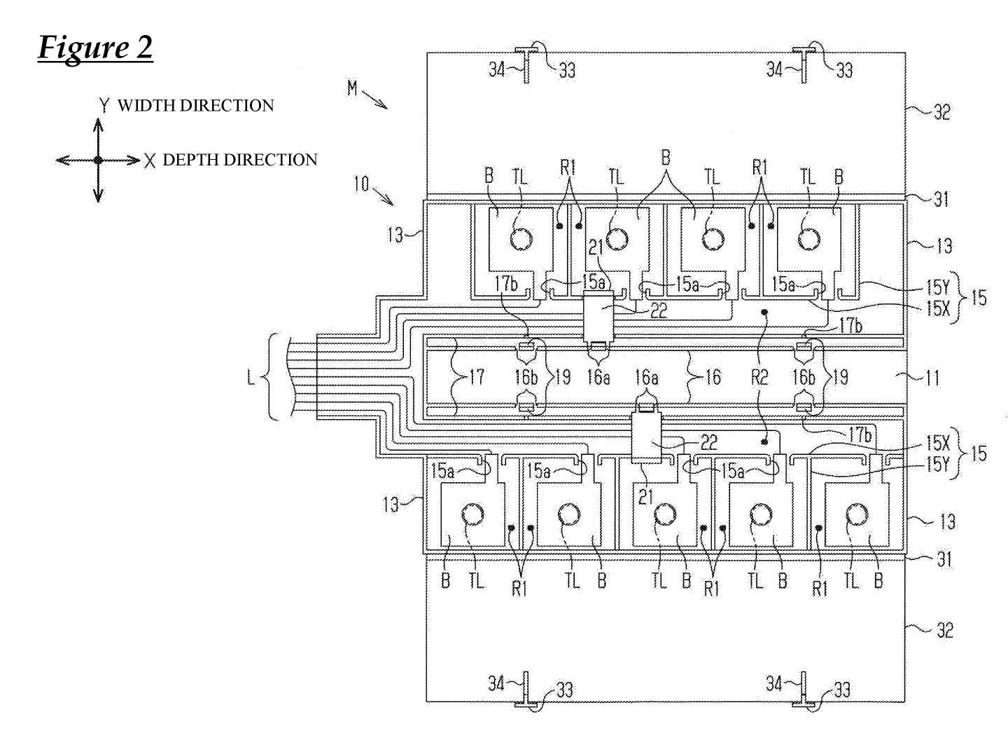

As shown in FIG. 2, the inner space of the housing 10 is partitioned into a plurality of terminal chambers R1 that correspond to the terminals TL of the secondary battery BT. In total, nine terminal chambers R1 are provided. Specifically, five terminal chambers R1 are provided on one side (the lower side in FIG. 2) of the housing 10 relative to the center of the housing 10 in the width direction, and four terminal chambers R1 are provided on the other side (the upper side in FIG. 2). Through holes are respectively provided in the terminal chambers R1 so as to penetrate through the bottom wall portion 11. The terminals TL of the secondary battery BT are inserted into the through holes from below. In the terminal chambers R1, bus bars B that have a plate shape and are electrically connected to the terminals TL of the secondary battery BT are provided on the bottom wall portion 11.

As shown in FIGS. 1 and 2, the terminal chambers R1 are separated from each other by partition walls 15 that stand upright on the upper surface of the bottom wall portion 11. The partition walls 15 include longitudinal wall portions 15X that extend in the depth direction. A plurality of transverse wall portions 15Y extend outward in the width direction from the outer surface of each longitudinal wall portion 15X in the width direction. The transverse wall portions 15Y extend to the inner surface of each outer peripheral wall portion 13. The length (height) of the longitudinal wall portions 15X and the transverse wall portions 15Y standing on the bottom wall portion 11 is slightly smaller than the length (height) of the outer peripheral wall portions 13 standing on the bottom wall portion 11. The longitudinal wall portions 15X out of the partition walls 15 are provided with opening portions 15a, one for each terminal chamber R1. Partition walls 15 (a longitudinal wall portion 15X and a plurality of transverse wall portions 15Y) are provided on both sides in the width direction so as to correspond to the terminal chambers R1 provided on both sides in the width direction. In FIGS. 1 and 2, only some of the plurality of transverse wall portions 15Y are assigned reference numerals.

As shown in FIG. 2, the inner space of the housing 10 is partitioned to form wiring housing chambers R2 on the center side in the width direction relative to the terminal chambers R1. The wiring housing chambers R2 are for housing the wires L, which are electrically connected to the secondary battery BT. In total, two wiring housing chamber R2 are formed, one corresponding to the terminal chambers R1 on one side in the width direction and the other corresponding to the terminal chambers R1 on the other side in the width direction. The wires L, which extend from the bus bars B in the terminal chambers R1, are led into the wiring housing chambers R2 via the opening portions 15a of the longitudinal wall portions 15X.

As shown in FIG. 2, the wiring housing chambers R2 are separated from each other by partition walls 16 that stand upright on the upper surface of the bottom wall portion 11. The partition walls 16 extend in the depth direction on the center side in the width direction relative to the longitudinal wall portions 15X of the partition walls 15. The partition walls 16 extend along the entire length of the bottom wall portion 11 in the depth direction. In the present embodiment, a space that is located on the center side in the width direction relative to the terminal chambers R1, out of the inner space of the housing 10, is partitioned by the partition walls 16, and a space that is located on the outer side in the width direction relative to the partition walls 16 and is on the inner side in the width direction relative to the longitudinal wall portions 15X of the partition walls 15 functions as the wiring housing chambers R2. Two partition walls 16 are provided with a gap therebetween so as to correspond to the terminal chambers R1 on both sides in the width direction. Note that the space between the two partition walls 16 is used to allow wires, which are led in from the outside, to pass through.

As shown in FIG. 1, restriction walls 17 stand upright on the upper surface of the bottom wall portion 11. The restriction walls 17 extend in the depth direction on the outer side of the partition walls 16 in the width direction. The distance between the restriction walls 17 and the partition walls 16 is shorter than the distance between the longitudinal wall portions 15X of the partition walls 15 and the restriction walls 17.

Small covers 22 are coupled to the upper ends of the longitudinal wall portions 15X of the partition walls 15, using hinges 21. The small covers 22 have a rectangular plate shape. The length of the small covers 22 in the depth direction is shorter than or equal to half of the length of the terminal chambers R1 in the depth direction. The length of the small covers 22 extending from the upper ends of the longitudinal wall portions 15X is substantially the same as the distance between the longitudinal wall portions 15X and the partition walls 16. The hinges 21 have a smaller thickness than the longitudinal wall portions 15X and the small covers 22, and thus have less flexural rigidity than the longitudinal wall portions 15X and the small covers 22. That is, the hinges 21 serve as so-called thin hinges. The small covers 22 are pivotable about the hinges 21 relative to the upper ends of the longitudinal wall portions 15X. When the small covers 22 are brought into a closed state by being pivoted toward the inner side in the width direction, the wiring housing chambers R2 are partially covered by the small covers 22 from above. In the present embodiment, in total, two small covers 22, one for each side in the width direction, are provided so as to correspond to the wiring housing chambers R2.

Lock pieces 23 that are substantially U-shaped protrude from the leading edges of the small covers 22 (the edges that are located farther from the hinges 21 than the other edges are). Each lock piece 23 is formed such that both ends of the U shape are coupled to the leading edge of a small cover 22. The lock pieces 23 protrude at a right angle from the small covers 22 so as to extend downward when the small covers 22 are in a closed state. The protrusion length of the lock pieces 23 from the small covers 22 is smaller than the length of the longitudinal wall portions 15X of the partition walls 15 standing on the bottom wall portion 11.

Each partition wall 16 is provided with a pair of first slits 16a that extend downward from the upper end of the partition wall 16. The distance between each pair of first slits 16a is shorter than the length of the above-described lock pieces 23 in the depth direction. Each pair of first slits 16a are located at positions that correspond to a small cover 22 in the depth direction.

As shown in FIG. 1, a first lock claw 18 is provided at a position between the pair of first slits 16a in each partition wall 16. The first lock claws 18 protrude outward in the width direction from the outer surfaces of the partition walls 16 in the width direction. When the small covers 22 are brought into a closed state by being pivoted about the hinges 21 toward the center in the width direction, each first lock claw 18 is fitted into the central space of a lock piece 23, which is substantially U-shaped, and thus the lock pieces 23 and the first lock claws 18 engage with each other. In a state where the lock pieces 23 and the first lock claws 18 engage with each other, the small covers 22 are held in a closed state.

Each restriction wall 17 is provided with a recessed portion 17a that is cut out downward from the upper edge of the restriction wall 17. The length of the cutouts of the recessed portions 17a from the upper edges of the restriction walls 17 is substantially the same as the thickness of the small covers 22. The recessed portions 17a are located at positions that correspond to the small covers 22 in the depth direction. The range of the cutouts of the recessed portions 17a in the depth direction is substantially the same as the length of the small covers 22 in the depth direction. When the small covers 22 are in a closed state, the small covers 22 are fitted into the recessed portions 17a, and the upper surfaces of the small covers 22 in a closed state and the upper ends of the restriction walls 17 where the recessed portions 17a are not provided are flush.

As shown in FIG. 1, large covers 32 that have a rectangular plate shape are coupled to the upper ends of portions of each outer peripheral wall portion 13 that extend in the depth direction, using hinges 31. The length of the large covers 32 in the depth direction is the same as the length of the bottom wall portion 11 in the depth direction. That is, the large covers 32 are provided along the entire length of the portions of each outer peripheral wall portion 13 that extend in the depth direction. The length of the large covers 32 extending from the upper ends of the outer peripheral wall portions 13 is substantially the same as the distance between the portions of the outer peripheral wall portions 13 that extend in the depth direction and the partition walls 16. The hinges 31 have a smaller thickness than the outer peripheral wall portions 13 and the large covers 32, and thus have less flexural rigidity than the outer peripheral wall portions 13 and the large covers 32. That is, the hinges 31 serve as so-called thin hinges. The large covers 32 are pivotable about the hinges 31 relative to the upper ends of the outer peripheral wall portions 13. When the large covers 32 are brought into a closed state by being pivoted toward the inner side in the width direction, the terminal chambers R1 and the wiring housing chambers R2 are entirely covered by large covers 32 from above.

Lock pieces 33 that are substantially U-shaped protrude from the leading edges of the large covers 32 (the edges that are located farther from the hinges 31 than the other edges are). Each lock piece 33 is formed such that both ends of the U shape are coupled to the leading edge of a large cover 32. The lock pieces 33 protrude at a right angle from the large covers 32 so as to extend downward when the large covers 32 are in a closed state. The protrusion length of the lock pieces 33 from the large covers 32 is shorter than the length of the outer peripheral wall portions 13 standing on the bottom wall portion 11. Two lock pieces 33 are provided for one large cover 32 so as to be separated from each other in the depth direction. In the present embodiment, the lock pieces 33 correspond to the first lock portion.

Each partition wall 16 is provided with two pairs of second slits 16b that extend downward from the upper end of the partition wall 16. The distance between each pair of second slits 16b is shorter than the length of the above-described lock pieces 33 in the depth direction. Each pair of second slits 16b are located at positions that correspond to a lock piece 33 in the depth direction.

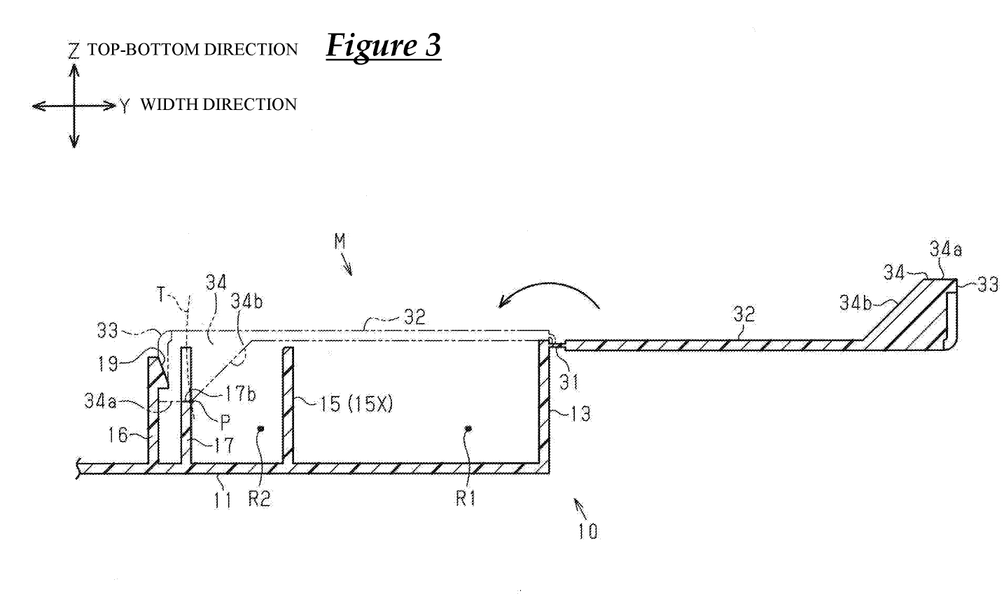

As shown in FIGS. 1 and 3, second lock claws 19 with which lock pieces 33 engage are provided at positions between each pair of second slits 16b in each partition wall 16. As shown in FIG. 3, the second lock claws 19 protrude from the outer surfaces of the partition walls 16 in the width direction toward the hinges 31 (toward the right in FIG. 3). When the large covers 32 are brought into a closed state by being pivoted about the hinges 31 toward the center in the width direction, each second lock claw 19 is fitted into the central space of a lock piece 33, which is substantially U-shaped, and thus the lock pieces 33 and the second lock claws 19 engage with each other. In a state where the lock pieces 33 and the second lock claws 19 engage with each other, the large covers 32 are held in a closed state. In the present embodiment, the second lock claws 19 correspond to the second lock portion. Note that the terminals TL and the bus bars B in the wiring housing chambers R2 are omitted from FIG. 3.

As shown in FIGS. 1 and 3, the large covers 32 are provided with guide portions 34 that protrude downward when the large covers 32 are in a closed state. The guide portions 34 are substantially plate shaped. The guide portions 34 are coupled to central portions, in the depth direction, of the surfaces of the lock pieces 33 on the hinge 31 side. Each guide portion 34 is trapezoidal in plan view in the depth direction, and the maximum height (the maximum protrusion length of the guide portions 34 from the large covers 32) is the same as the protrusion length of the lock pieces 33 from the large covers 32. Thus, each guide portion 34 has a flat surface 34a that is flush with the leading end surface of a lock piece 33, and an inclined surface 34b that is inclined such that the protrusion length of the guide portion 34 decreases in a direction from a hinge 31 side end of the flat surface 34a toward the hinge 31.

As shown in FIG. 3, when a large cover 32 is in a closed state, a vertex P of the inclined surface 34b at the protruding leading end of the inclined surface 34b is located closer to the hinge 31 than the side surface of the restriction wall 17 (the left side surface in FIG. 3) is, the side surface being located farther from the hinge 31 than the other side surface is. Also, in the present embodiment, the shape of each guide portion 34 is set such that, when the large cover 32 is pivoted about the hinge 31, the side surface of the restriction wall 17, which is located farther from the hinge 31 than the other side surface is, is located farther from the hinge 31 than a trajectory T of the vertex P of the inclined surface 34b is.

As shown in FIGS. 1 and 3, each restriction wall 17 is provided with slits 17b that extend downward from the upper edge of the restriction wall 17. As shown in FIG. 3, the length of the slits 17b in the top-bottom direction is substantially the same as the protrusion length of the lock pieces 33 from the large covers 32. The width of the slits 17b in the depth direction is slightly larger than the thickness of the guide portions 34. The slits 17b are located at positions that correspond to the guide portions 34 in the depth direction.

The battery wiring module M with the above-described configuration is integrally molded as one object by pouring resin into a cavity that is formed in a mold, and hardening the resin. Note that an example of the material of the battery wiring module M is polypropylene.

The following describes the actions of the battery wiring module M with the above-described configuration when the battery wiring module M is attached to the secondary battery BT.

The housing 10 of the battery wiring module M is attached to the upper side of the secondary battery BT. In a state where the housing 10 is attached to the upper side of the secondary battery BT, the terminals TL of the secondary battery BT protrude into the terminal chambers R1 defined in the housing 10, and are electrically connected to the bus bars B in the terminal chambers R1. Then, the wires L that extend from the bus bars B in the terminal chambers R1 are led out into the wiring housing chambers R2 via the opening portions 15a of the partition walls 15, and are led out to the extension portion 12 side. The wires L are arranged in the wiring housing chambers R2 in this way, and then the small covers 22 and the large covers 32 are brought into a closed state by being pivoted toward the center side in the width direction. Thus, the wires L arranged in the wiring housing chambers R2 are pressed by the small covers 22 from above, and the wiring housing chambers R2 and the terminal chambers R1 are covered by the large covers 32 from above.

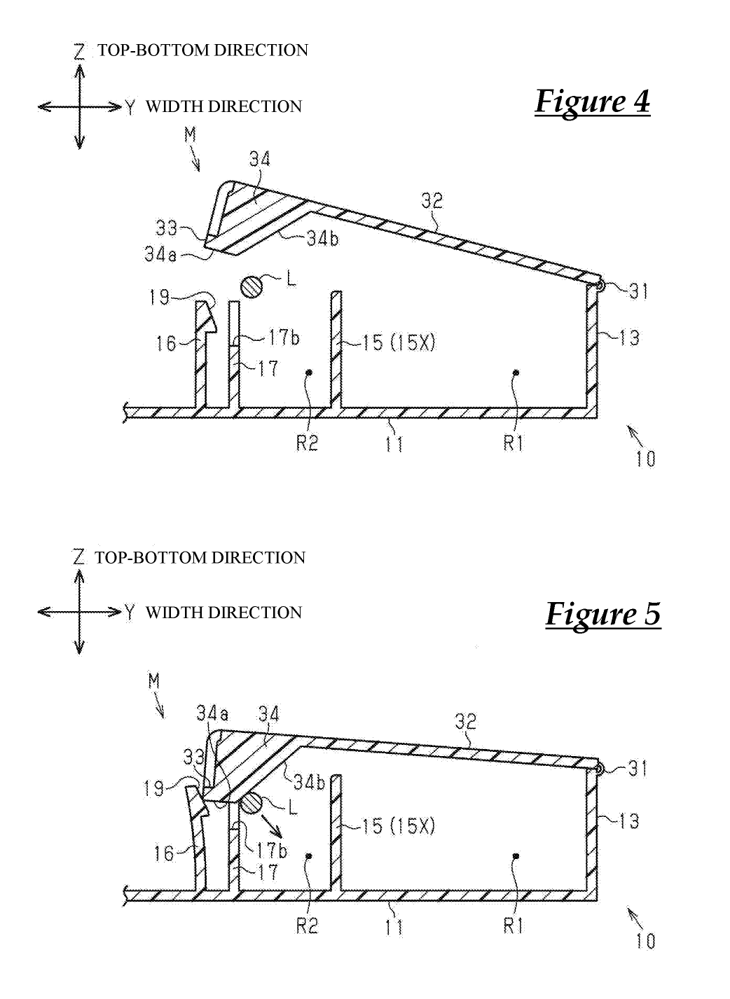

Here, when the wires L are arranged in the wiring housing chambers R2, some of the wires L may protrude above a wiring housing chamber R2 as shown in FIG. 4. If a large cover 32 is pivoted to the center side in the width direction in this state, a wire L may get caught between the large cover 32 and the restriction wall 17, or get caught between the leading end of the lock piece 33 and the leading end of the second lock claw 19. If a wire L gets caught, there is the risk of the wire L breaking or the like.

In this regard, with the above-described embodiment, even if a wire L is located above a wiring housing chamber R2 at a position on the restriction wall 17 side, the wire L abuts against the inclined surface 34b of the guide portion 34 while the large cover 32 is pivoted, as shown in FIG. 5. The inclined surface 34b of each guide portion 34 is formed such that the protrusion length decreases in a direction toward the hinge 31 that is the pivot axis. Therefore, the wire L that has abutted against the inclined surface 34b of the guide portion 34 is pressed obliquely downward toward the hinge 31, and is guided into the wiring housing chamber R2.

As a result of the large cover 32 being pivoted so as to be substantially parallel with the bottom wall portion 11 as indicated by a two-dot chain line in FIG. 3, the second lock claw 19, which protrudes from the partition wall 16, and the lock piece 33, which protrude from the large cover 32, engage with each other, and the large cover 32 is held in a closed state. When a large cover 32 is to be opened, each portion inserted between a pair of second slits 16b in a partition wall 16 is pressed from above using a finger or a tool so that each portion inserted between a pair of second slits 16b warps away from the hinge 31. As a result, the second lock claw 19 and the lock piece 33 disengage from each other, and thus the large cover 32 is allowed to pivot. The same applies to the small covers 22. A portion inserted between a pair of first slits 16a in a partition wall 16 is pressed from above using a finger or a tool so that the partition wall 16 warps away from the hinge 31, and thus a small cover 22 is allowed to pivot.

With the above-described embodiment, the following effects can be achieved.

In the above-described embodiment, when a large cover 32 is to be pivoted and closed, even if a wire L protrudes above a wiring housing chamber R2, the wire L can abut against the inclined surface 34b of the guide portion 34 while the large cover 32 is closed. Then, the wire L is pressed toward and housed in the wiring housing chamber R2 that is located closer to the hinge 31 than the restriction wall 17 is, by the inclined surface 34b of the guide portion 34. Therefore, it is possible to prevent a wire L from getting caught between a large cover 32 and a restriction wall 17, a partition wall 16, or the like of the housing 10 when the large cover 32 is closed.

In the above-described embodiment, the guide portions 34 are coupled to the lock pieces 33. Therefore, the guide portions 34 also serve as reinforcement ribs for increasing the strength of portions of the lock pieces 33 and the large covers 32 in the vicinity of the lock pieces 33. Thus, for example, when the large covers 32 are repeatedly opened and closed, so-called “wilting” or the like, which is a decrease in the strength of the lock pieces 33, is unlikely to occur.

As an engagement relationship between the second lock claws 19 and the lock pieces 33, it is possible to conceive of another engagement relationship that is different from the relationship in the above-described embodiment, in which the second lock claws 19 protrude from the partition walls 16 toward the center side in the width direction, and the lock pieces 33 are located on the center side in the width direction relative to the partition walls 16 when the large covers 32 are in a closed state. Also, if this engagement relationship is employed, when the engagement relationship between the second lock claws 19 and the lock pieces 33 is to be released, it is possible to conceive of pressing the leading ends of the lock pieces 33 from below using a finger or a tool so that the leading ends of the lock pieces 33 warp toward the center side in the width direction. However, in the battery wiring module M, the secondary battery BT is located below the housing 10 (the bottom wall portion 11), and therefore it is difficult to press the leading ends of the lock pieces 33 from below.

In this regard, with the above-described embodiment, it is possible to release the large covers 32 from a closed and held state by inserting a finger or a tool from above the battery wiring module M and causing portions of the partition walls 16 where the second lock claws 19 are provided to warp away from the hinges 31. Therefore, when releasing the large covers 32 from a closed and held state, it is easier to perform an operation compared to inserting a finger or a tool from a lower side on which the secondary battery BT is located.

In the above-described embodiment, even if the lock pieces 33 are displaced toward the hinges 31 due to the large covers 32 warping, for example, the protruding ends of the lock pieces 33 abut against the restriction walls 17 and the lock pieces 33 are restricted from moving further toward the hinges 31. Therefore, it is possible to prevent the large covers 32 from excessively warping so that the lock pieces 33 separates from the second lock claws 19 and the large covers 32 are unintentionally released from a closed and held state.

In the above-described embodiment, the slits 17b are provided in the restriction walls 17, and when the large covers 32 are in a closed state, the guide portions 34 are inserted into the slits 17b. Therefore, when the large covers 32 are pivoted and closed, the guide portions 34 and the restriction walls 17 do not interfere with each other.

Assume a case in which a guide portion 34 in the above-described embodiment does not have a flat surface 34a and the vertex P of the protruding leading end of the inclined surface 34b is located on the leading end surface of the lock piece 33. In this case, when a wire L that protrudes above the wiring housing chamber R2 abuts against the inclined surface 34b near the vertex P, the wire L cannot be guided in a direction toward the hinge 31 from the restriction wall 17, and the wire L may get caught between the inclined surface 34b of the guide portion 34 and the upper end of the restriction wall 17, or be guided into a space between the restriction wall 17 and the partition wall 16.

In the above-described embodiment, when the large covers 32 are pivoted about the hinges 31, the surfaces of the restriction walls 17, which are located farther from the hinges 31 than the other surfaces are, are located farther from the hinges 31 than the trajectories T of the vertices P of the guide portions 34 are. Therefore, a wire L that protrudes above a wiring housing chamber R2 can be reliably located closer to the hinge 31 than the restriction wall 17 is. As a result, it is possible to prevent the wires L from getting caught between the inclined surface 34b of a guide portion 34 and the upper end of a restriction wall 17, or being guided into a space between a restriction wall 17 and a partition wall 16, as described above.

In the above-described embodiment, if a guide portion 34 is not provided with a flat surface 34a, the thickness of a portion of the inclined surface 34b of the guide portion 34 near the vertex P (the thickness in the left-right direction in FIG. 3, for example) is reduced. In the case of integrally molding the battery wiring module M as one object by pouring resin into the cavity of a mold as in the above-described embodiment, it is difficult to fill a portion of the cavity that corresponds to the thin portion of the battery wiring module M with resin. If the battery wiring module M is molded with a portion of the cavity not filled with resin, the battery wiring module M is a defective product and the yield decreases.

With the above-described embodiment, the guide portions 34 have the flat surfaces 34a that are flush with the leading end surfaces of the lock pieces 33, and thus the guide portions 34 have a sufficient thickness. That is, portions at which the guide portions 34 and the lock pieces 33 are coupled to each other are prevented from being excessively thin. Therefore, when integrally molding the battery wiring module M as one object by pouring resin into the cavity of a mold, it is possible to reliably distribute resin to positions that correspond to the vertices P of the guide portions 34 in the cavity of the mold. Thus, it is possible to increase the yield of the battery wiring module M.

The above-described embodiment can be modified as follows.

The number and arrangement of terminal chambers R1 and wiring housing chambers R2 of the battery wiring module M according to the above-described embodiment are examples, and may be modified as appropriate. Also, for example, a plurality of the same or similar battery wiring modules M may be coupled to each other in the depth direction and used as an integrated module.

The battery wiring module M is not limited to an integrally molded object. For example, the housing 10, the small covers 22, and the large covers 32 may be separately molded and attached to each other. Also, the material of the battery wiring module M is not necessarily resin, and any material may be used as long as the bus bars B and the wires L can be reliably insulated.

The guide portions 34 are not necessarily provided with the flat surfaces 34a. For example, the guide portions 34 may be formed as to have a substantially right triangular shape in plan view when the guide portions 34 are seen in the depth direction.

The trajectories T of the vertices P of the guide portions 34 when the large covers 32 are pivoted about the hinges 31 may be located farther from the hinges 31 than the surfaces of the restriction walls 17 are, the surfaces being located farther from the hinges 31 than the other surfaces are. For example, if the wires L arranged in the wiring housing chambers R2 are relatively thick, it is unlikely that the wires L are pushed by the guide portions 34 to the gaps between the partition walls 16 and the restriction walls 17 even if the above-described configuration is employed.

The restriction walls 17 may be omitted. As described above, the guide portions 34 are coupled to the lock pieces 33 so that the strength of the lock pieces 33 and portions of the large covers 32 in the vicinity of the lock pieces 33 is improved. Therefore, even if the restriction walls 17 are omitted, it is unlikely that the lock pieces 33 and the portions of the large covers 32 in the vicinity of the lock pieces 33 warp and the lock pieces 33 and the second lock claws 19 disengage from each other.

Although the lock pieces 33 protrude from the leading edges of the large covers 32 in the above-described embodiment, the present invention is not limited to such a configuration. That is, the lock pieces 33 may protrude from positions that are distanced from the leading edges of the large covers 32 toward the hinges 31. The positions of the lock pieces 33 may be appropriately determined in consideration of the positions of the second lock claws 19 to which the lock pieces 33 are locked, the dimension of the large covers 32, and so on.

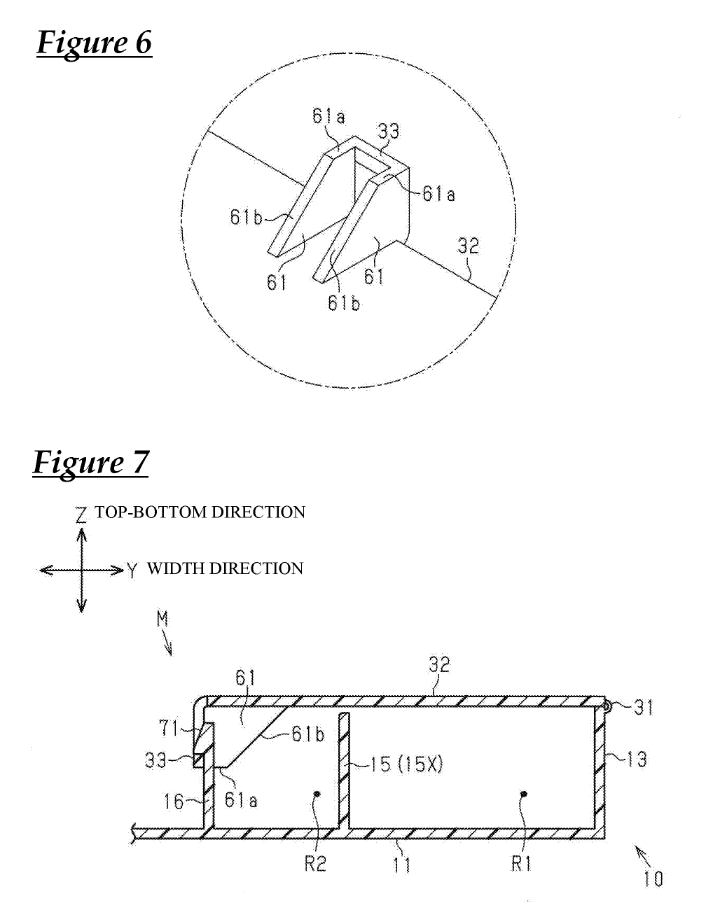

In the above-described embodiment, one guide portion 34 is coupled to one lock piece 33. However, a plurality of guide portions may be coupled to one lock piece 33. For example, in the example shown in FIG. 6, two guide portions 61 are coupled to one lock piece 33. Each guide portion 61 has a flat surface 61a and an inclined surface 61b that is inclined such that the protrusion length of the guide portion 61 decreases in a direction toward the hinge 31 (to the lower left in FIG. 6). The guide portions 61 have the same shape and size. Each guide portion 61 is coupled to one of the two ends of a lock piece 33 in the depth direction. In this example, two slits 17b may be provided in each restriction wall 17 in correspondence with two guide portions 61.

In a configuration in which two guide portions 61 are coupled to one lock piece 33, the directions in which lock claws protrude from the partition walls 16 may be changed. For example, in the example shown in FIG. 7, a lock claw 71 protrudes away from the hinge 31, from the surface of the partition wall 16 (the left surface in FIG. 7), the surface being farther from the hinge 31 than the other surface is. Also, in this modification, two guide portions 61 are inserted into a pair of second slits 16b in the partition wall 16, and the guide portions 61 do not interfere with the partition wall when the large cover 32 is pivoted.

Even in this modification, if the lock piece 33 is substantially U-shaped, it is possible to press the lock claw 71 with a finger or a tool through the space surrounded by the U shape. Then, by causing the partition wall 16 to warp toward the hinge 31 using a finger or a tool, it is possible to disengage the lock piece 33 and the lock claw 71 from each other. Note that, in this modification, even if the restriction walls 17 are provided closer to the hinges 31 than the partition walls 16 are, it is unlikely that the restriction walls 17 will prevent the lock pieces 33 from excessively warping. Therefore, as shown in FIG. 7, the restriction walls 17 may be omitted.

Instead of or in addition to the guide portions 34 being coupled to the lock pieces 33 that protrude from the large covers 32, guide portions may be coupled to the lock pieces 23 that protrude from the small covers 22. If this is the case, slits that extend downward from the upper ends of the recessed portions 17a of the restriction walls 17 may be provided such that the guide portions that are coupled to the lock pieces 23 are inserted into the slits when the small covers 22 are closed.

In the above-described embodiment, the large covers 32 are configured to be pivotable relative to the upper ends of the outer peripheral wall portion 13. However, the present invention is not limited to such a configuration. If there are other wall portions that are provided on the outer side of the partition walls 16 in the width direction so as to stand upright and extend in the depth direction, the large covers 32 may be coupled to the upper ends of the wall portions so as to be pivotable relative to the upper ends.

The lock pieces 33 (the first lock pieces) are not necessarily substantially U-shaped. For example, first lock portions that are plate shaped and protrude from the leading edges of the large covers 32 may be provided, and recessed portions may be provided in the surfaces of the first lock portions on the hinge 31 side. Even in this modification example, the lock pieces 33 are fitted into and engaged with the recessed portions of the first lock portions.

Also, for example, the first lock portions may be constituted by plate-shaped members that protrude from the leading edges of the large covers 32 and protruding portions that protrude from the surfaces of the plate-shaped members on the hinge 31 side toward the hinges 31. If this is the case, the partition walls 16 may be provided with dent portions instead of the lock claws, into which the above-described protruding portions are fitted.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

LIST OF REFERENCE NUMERALS

| BT: | Secondary Battery |
|---|---|
| TL: | Terminal |
| M: | Battery Wiring Module |
| L: | Wire |
| B: | Bus Bar |
| R1: | Terminal Chamber |
| R2: | Wiring Housing Chamber |
| P: | Vertex of Inclined Surface |
| T: | Trajectory |
| 10: | Housing |
| 11: | Bottom Wall Portion |
| 12: | Extension Portion |
| 13: | Outer Peripheral Wall Portion |
| 15: | Partition Wall |
| 15X: | Longitudinal Wall Portion |
| 15Y: | Transverse Wall Portion |
| 15a: | Opening Portion |
| 16: | Partition Wall |
| 16a: | First Slit |
| 16b: | Second Slit |
| 17: | Restriction Wall |
| 17a: | Recessed Portion |
| 17b: | Slit |
| 18: | First Lock Claw |
| 19: | Second Lock Claw |
| 21: | Hinge |
| 22: | Small Cover |
| 23: | Lock Piece |
| 31: | Hinge |
| 32: | Large Cover |
| 33: | Lock Piece |
| 34: | Guide Portion |
| 34a: | Flat Surface |
| 34b: | Inclined Surface |
| 61: | Guide Portion |
| 61a: | Flat Surface |
| 61b: | Inclined Surface |
| 71: | Lock Claw |

What is claimed is:

1. A battery wiring module that is provided with a housing that is to be attached to an on-board secondary battery, and in which a wiring housing chamber for housing wiring that is electrically connected to the secondary battery is defined by a partition wall that stands upright on a bottom surface of the housing,
wherein a cover is coupled to an upper end of a wall portion that stands upright on the bottom surface of the housing, so as to be pivotable relative to the upper end of the wall portion,
the cover is provided with a first lock portion that protrudes downward when the cover is closed so as to cover the wiring housing chamber from above,
the partition wall is provided with a second lock portion that engages with the first lock portion to hold the cover in a closed state,
the cover is provided with a guide portion that protrudes downward when the cover is in a closed state, and
the guide portion is coupled to a side of the first lock portion, the side being closer to a pivot axis of the cover than the other side is, and the guide portion has an inclined surface that is inclined such that a protrusion length of the guide portion decreases in a direction toward the pivot axis.

2. The battery wiring module according to claim 1,
wherein the first lock portion protrudes from an edge of the cover, the edge being located farther from the pivot axis than the other edge is,
the second lock portion is provided so as to protrude from the partition wall toward the pivot axis of the cover, and
the first lock portion is located closer to the pivot axis than the partition wall is when the cover is in a closed state.

3. The battery wiring module according to claim 2,
wherein a restriction wall that stands upright on the bottom surface of the housing is provided at a position that is closer to the pivot axis than the partition wall is, so as to face the partition wall,
the restriction wall is provided with a slit that extends downward from an upper end of the restriction wall, and
when the cover is in a closed state, the first lock portion is located between the partition wall and the restriction wall, and the guide portion is inserted into the slit.

4. The battery wiring module according to claim 3,
wherein, when the cover is pivoted about the pivot axis, a side surface of the restriction wall, the side surface being located farther from the pivot axis than the other side surface is, is located farther from the pivot axis than a trajectory of a vertex of the inclined surface at a protruding leading end of the inclined surface is.

5. The battery wiring module according to claim 1,
wherein the cover, the first lock portion, and the guide portion are integrally molded as one object that is made of resin, and
the guide portion has a flat surface that is flush with a protruding leading end surface of the first lock portion.
